(19) United States
(12) Patent Application Publication
(10) Pub. No.: US 2007/0126376 A1
(43) Pub. Date: Jun. 7, 2007

(54) DRIVING CIRCUIT CAPABLE OF REDUCING POWER CONSUMPTION

(76) Inventor: Liang-Chung Wu, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 11/565,600

(22) Filed: Nov. 30, 2006

(30) Foreign Application Priority Data
Dec. 1, 2005 (TW) 094142371

(51) Int. Cl. H05B 39/00

(52) U.S. Cl. 315/312

(57) ABSTRACT

An LED driving circuit includes an LED, a current source, a comparator and a voltage converter. A first end of the current source is coupled to a first end of the LED. The comparator includes a first input end coupled to a reference voltage and a second input end coupled to the first end of the current source. The comparator generates a control voltage at an output end based on voltage levels of the first end of the current source and the reference voltage. The voltage converter includes a first input end coupled to an input voltage, a control end coupled to the output end of the comparator, and an output end coupled to a second end of the LED. The voltage converter generates an adaptive regulated voltage by comparing the voltage level of the first end of the current source with the reference voltage.

### BACKGROUND OF THE INVENTION

1. Field of the Invention

The present invention relates to a driving circuit, and more particularly, to a driving circuit of an LED display capable of reducing power consumption.

2. Description of the Prior Art

Recently, light emitting diodes (LEDs) have been applied in various fields. Compared to conventional incandescent lamps, the LED has advantages such as low power consumption, long lifetime, short warm-up time, and fast reaction speed, etc. Together with its small size, ease for mass production and anti-shake ability, the LED is particularly suitable for applications in small-sized or array devices. For example, the LED has been widely used in outdoor displays, traffic lights, mobile phones and personal digital assistants (PDAs). Therefore, there is increasing demand for more stable LED driving circuits.

An LED is a semiconductor device that directly converts electrical energy into optical energy. Since the forward-biased current of the LED increases exponentially with it applied forward-biased voltage, the LED is normally driven using a current source for achieving more uniform illumination. Reference is made to FIG. 1 for a diagram illustrating an LED driving circuit 10 without a current source. The LED driving circuit 10 includes a light emitting diode LED, a resistor R, and a buck converter 14. An input voltage Vᵢₙ is supplied to an input end of the buck converter 14. A resistor voltage can be calculated by subtracting the forward-biased voltage of the LED from an output voltage Vₒᵤₜ of the buck converter 14. The resistance of the resistor R can be set so that the resistor voltage across the resistor R provides a forward-biased current I_{f} required for operating the LED. However, due to variations of material purity and manufacturing processes, the actual forward-biased voltages of different LEDs, which are designed to have the same nominal forward-biased voltage, may also vary. In the prior art LED driving circuit 10, the resistor R has a fixed resistance. When the forward-biased voltage of the LED deviates from the nominal value, the voltage established across the LED, as well as the corresponding forward-biased current I_{f}, also changes accordingly. The deviated forward-biased current I_{f} may influence the quality of the LED. Also, if the input voltage Vᵢₙ somehow becomes unstable, the reference output voltage Vₒᵤₜ generated by the buck converter 14 is also affected, causing the forward-biased current I_{f} to fluctuate and influencing the illuminant stability of the LED.

Reference is made to FIG. 2 for a diagram illustrating a prior art LED driving circuit 20. The LED driving circuit 20 includes a light emitting diode LED, a current source Iₛ, and a buck converter 24. An input voltage Vᵢₙ is supplied to an input end of the buck converter 24. The buck converter 24 converts the input voltage Vᵢₙ into a forward-biased voltage Vₒᵤₜ required for operating the LED. The current source Iₛ provides a forward-biased current I_{f} required for operating the LED. When the forward-biased voltage of the LED deviates from the nominal value, the resulting voltage variation established across the LED is compensated by the current source Iₛ. It is therefore preferable to establish a larger voltage difference across the current source Iₛ than it actually requires. The extra power consumption, calculated by multiplying the extra voltage difference across the current source Iₛ with the forward-biased current I_{f}, creates extra heat, thus making heat dissipation more difficult. The reliability and lifetime of the display devices using the LED driving circuit 20 are also affected.

Reference is made to FIG. 3 for a diagram illustrating another prior art LED driving circuit 30. The LED driving circuit 30 includes a plurality of light emitting diodes LED₁-LEDₙ coupled in series, a current source Iₛ, and a buck converter 34. An input voltage Vᵢₙ is supplied to an input end of the buck converter 34. The buck converter 34 converts the input voltage Vᵢₙ into a forward-biased voltage Vₒᵤₜ required for operating the LED₁-LEDₙ. The current source Iₛ provides a forward-biased current I_{f} required for operating the LED₁-LEDₙ. Due to the series-coupled LED₁-LEDₙ, the LED driving circuit 30 is particularly suitable for high brightness applications. However, as the number of the LED₁-LEDₙ increases, a sum of forward-biased voltage variation resulting from each light emitting diode also increases. Therefore, a larger voltage difference has to be established across the current source Iₛ for compensating the sum of forward-biased voltage variation of the LED₁-LEDₙ. Though the prior art LED driving circuit 30 can provide higher illumination, it also results in higher power consumption, making heat dissipation even more difficult.

### SUMMARY OF THE INVENTION

The claimed invention provides a driving circuit capable of reducing power consumption comprising a current source having a first end coupled to a first end of a load for providing current required for operating the load; a comparator having a first input end coupled to a reference voltage and a second input end coupled to the first end of the current source for generating a control voltage based on voltage levels of the first end of the current source and the reference voltage; and a voltage converter having an input end coupled to an input voltage, a control end coupled to the output end of the comparator, and an output end coupled to a second end of the load for providing the load with an adaptive regulated voltage based on control voltages sent from the output end of the comparator.

The claimed invention also provides a driving circuit of an LED display capable of reducing power consumption comprising an LED for providing a light source; a current source having a first end coupled to a first end of the LED for providing forward-biased current required for operating the LED; a comparator having a first input end coupled to a reference voltage and a second input end coupled to the first end of the current source for generating a control voltage based on voltage levels of the first end of the current source and the reference voltage; and a voltage converter having an input end coupled to an input voltage, a control end coupled to the output end of the comparator, and an output end coupled to a second end of the LED for providing the LED with an adaptive regulated voltage based on control voltages sent from the output end of the comparator.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an LED driving circuit without a current source.

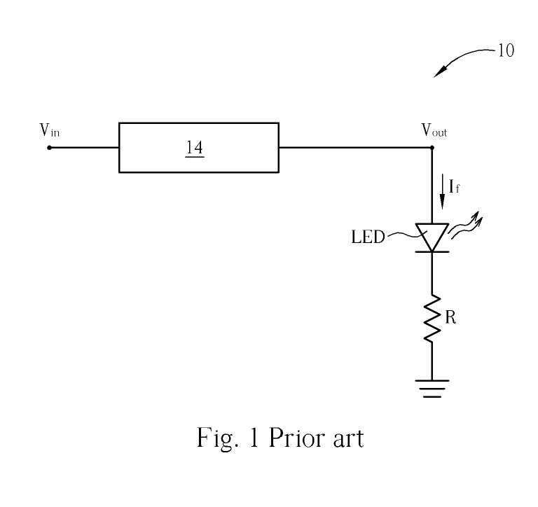

FIG. 2 is a diagram illustrating a prior art LED driving circuit.

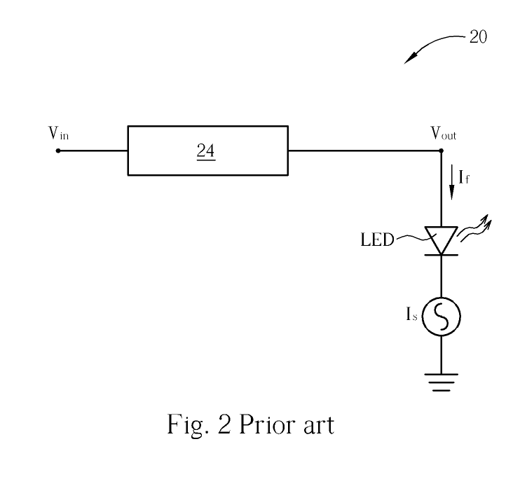

FIG. 3 is a diagram illustrating another prior art LED driving circuit.

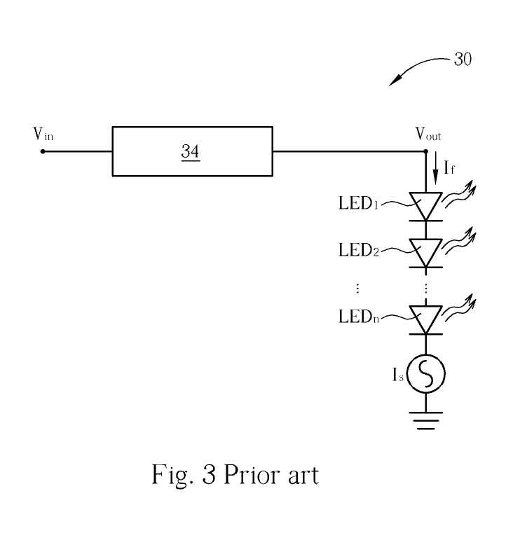

FIG. 4 is a diagram illustrating an LED driving circuit according to a first embodiment of the present invention.

FIG. 5 is a diagram of a boost converter in the present invention.

FIG. 6 is a diagram of a buck converter in the present invention.

FIG. 7 is a diagram illustrating an LED driving circuit according to a second embodiment of the present invention.

### DETAILED DESCRIPTION

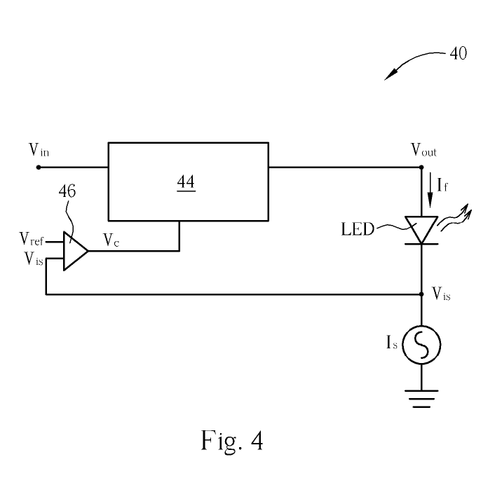

Reference is made to FIG. 4 for a diagram illustrating an LED driving circuit 40 according to a first embodiment of the present invention. The LED driving circuit 40 includes a light emitting diode LED, a current source Iₛ, a voltage converter 44, and a comparator 46. Vᵢₛ represents the voltage level of a first end of the current source Iₛ coupled to a cathode of the LED. A second end of the current source Iₛ can be coupled to ground. The current source Iₛ provides a forward-biased current I_{f} required for operating the LED. The voltage converter 44 includes a power input end coupled to an input voltage Vᵢₙ, a control end, and an output end. The comparator 46 includes two input ends and an output end. The first input end of the comparator 46 is coupled to a reference voltage V_{ref}, and the second input end of the comparator 46 is coupled to the first end of the current source Iₛ. The comparator 46 generates a control voltage V_{C} at its output end based on the voltages V_{ref} and Vᵢₛ, and sends the control voltage V_{C} to the control end of the voltage converter 44. The voltage converter 44 then generates an adaptive regulated voltage Vₒᵤₜ at its output end based on the control voltage V_{C}.

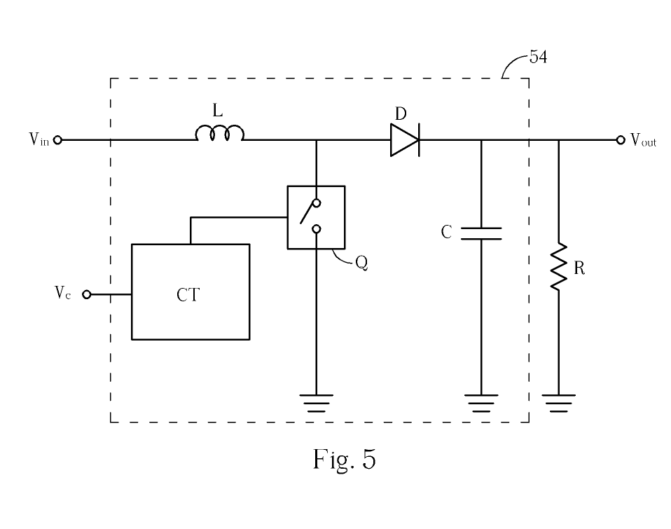

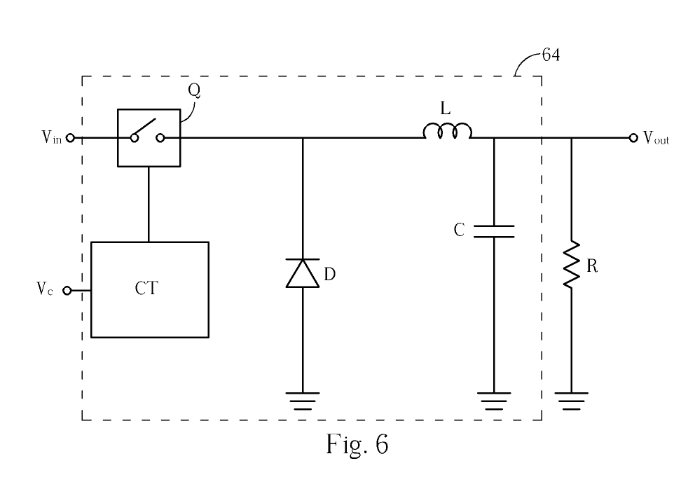

In the present invention, the voltage converter 44 can includes a boost converter 54 or a buck converter 64, respectively shown in FIG. 5 and FIG. 6. In FIG. 5 and FIG. 6, the boost converter 54 and the buck converter 64 each includes an inductor L, a capacitor C, a switching device Q, a diode D, and a control circuit CT. The switching device Q can include a metal oxide semiconductor field effect transistor (MOSFET), a bipolar junction transistor (BJT), or other devices providing similar functions. The diode D can include a Schottky diode, or other devices providing similar functions. The switching device Q and the diode D control current passages in the boost converter 54 and the buck converter 64. The control circuit CT includes an input end coupled to the output end of the comparator 46, and an output end coupled to the switching device Q. The control circuit CT controls when and how often the switching device Q is turned on/off based on the control voltage V_{C}. The turn-on/off of the switching device Q activates an effective output filter formed by the inductor L and the conductor C for boosting or lowering voltages. Therefore, the adaptive regulated voltage Vₒᵤₜ can be generated at each output end of the boost converter 54 and the buck converter 64. The boost converter 54 and the buck converter 64 shown in FIG. 5 and FIG. 6 are merely two embodiments of the present invention. The present invention can also use other types of voltage converters.

In the LED driving circuit 40 of the present invention, when the forward-biased voltage of the LED deviates from the nominal value or the input voltage Vᵢₙ fluctuates, the forward-biased voltage variation is fed to the second input end of the comparator 46 via the voltage Vᵢₛ obtained at the first end of the current source Iₛ. The comparator 46 generates a control voltage V_{C} at its output end based on the voltages V_{ref} and Vᵢₛ obtained at its first and second input ends. The voltage converter 44 then updates the adaptive regulated voltage Vₒᵤₜ based on the control voltage V_{C}. Therefore, the voltage established across the current source Iₛ can be corrected in real-time according to the actual forward-biased voltage of the LED. Even if the forward-biased voltage of the LED deviates from the nominal value or the input voltage Vᵢₙ fluctuates, the forward-biased voltage variation can be sent to the second input end of the comparator 46. The comparator 46 and the voltage converter 44 can then update the control voltage V_{C} and the adaptive regulated voltage Vₒᵤₜ accordingly, so that the current source Iₛ can receive a proper forward-biased voltage, and the exact amount of forward-biased current I_{f} required for operating the LED can be generated. Therefore, the LED driving circuit 40 of the present invention does not require an extra voltage difference across the current source Iₛ for compensating the forward-biased voltage variation of the LED. Power consumption and system temperature can thus be lowered, and the reliability and lifetime of display devices using the LED driving circuit 40 can be improved.

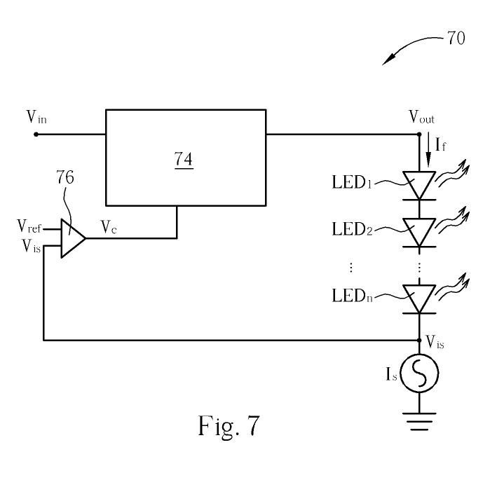

Reference is made to FIG. 7 for a diagram illustrating an LED driving circuit 70 according to a second embodiment of the present invention. The LED driving circuit 70 includes a plurality of light emitting diodes LED₁-LEDₙ coupled in series, a current source Iₛ, a voltage converter 74, and a comparator 76. Vᵢₛ represents the voltage level of a first end of the current source Iₛ coupled to a cathode of the LEDₙ. A second end of the current source Iₛ can be coupled to ground. The current source Iₛ provides a forward-biased current I_{f} required for operating the LED₁-LEDₙ. The voltage converter 74 includes a power input end coupled to an input voltage Vᵢₙ, a control end, and an output end. The comparator 76 includes two input ends and an output end. The first input end of the comparator 76 is coupled to a reference voltage V_{ref}, and the second input end of the comparator 76 is coupled to the first end of the current source Iₛ. The comparator 76 generates a control voltage V_{C} at its output end based on the voltages V_{ref} and Vᵢₛ, and sends the control voltage V_{C} to the control end of the voltage converter 74. The voltage converter 74 then generates an adaptive regulated voltage Vₒᵤₜ at its output end based on the control voltage V_{C}. The voltage converter 74 in the second embodiment of the present invention can include the boost converter 54 shown in FIG. 5, the buck converter 64 shown in FIG. 6, or other types of voltage converters.

In the LED driving circuit 70 of the present invention, when the forward-biased voltages of the LED₁-LEDₙ deviate from the nominal value or the input voltage Vᵢₙ fluctuates, the total forward-biased voltage variation is fed to the second input end of the comparator 76 via the voltage Vᵢₛ obtained at the first end of the current source Iₛ. The comparator 76 generates a control voltage V_{C} at its output end based on the voltages V_{ref} and Vᵢₛ obtained at its first and second input ends. The voltage converter 74 then updates the adaptive regulated voltage Vₒᵤₜ based on the control voltage V_{C}. Therefore, the voltage established across the current source Iₛ can be corrected in real-time according to the actual forward-biased voltages of the LED₁-LEDₙ. Even if the forward-biased voltages of the LED₁-LEDₙ deviates from their respective nominal values or the input voltage Vᵢₙ fluctuates, the total forward-biased voltage variation can be sent to the second input end of the comparator 76. The comparator 76 and the voltage converter 74 can then update the control voltage V_{C} and the adaptive regulated voltage Vₒᵤₜ accordingly, so that the current source Iₛ can receive a proper forward-biased voltage, and the exact amount of forward-biased current I_{f} required for operating the LED₁-LEDₙ can be generated. Therefore, the LED driving circuit 70 of the present invention does not require an extra voltage difference across the current source Iₛ for compensating the forward-biased voltage variation of the LED₁-LEDₙ. Power consumption and system temperature can thus be lowered, and the reliability and lifetime of display devices using the LED driving circuit 70 can be improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A driving circuit capable of reducing power consumption comprising:
a current source having a first end coupled to a first end of a load for providing current required for operating the load;
a comparator having a first input end coupled to a reference voltage and a second input end coupled to the first end of the current source for generating a control voltage based on voltage levels of the first end of the current source and the reference voltage; and
a voltage converter having an input end coupled to an input voltage, a control end coupled to the output end of the comparator, and an output end coupled to a second end of the load for providing the load with an adaptive regulated voltage based on control voltages sent from the output end of the comparator.

2. The driving circuit of claim 1 wherein the voltage converter includes a boost converter.

3. The driving circuit of claim 1 wherein the voltage converter includes a buck converter.

4. The driving circuit of claim 1 wherein the second end of the current source is coupled to ground.

5. The driving circuit of claim 1 wherein the voltage converter, the current source and the comparator are fabricated on a same chip.

6. The driving circuit of claim 1 wherein the load includes a light emitting diode (LED).

7. The driving circuit of claim 1 wherein the load includes a plurality of LEDs.

8. The driving circuit of claim 1 further comprising an input power source coupled to the input end of the voltage converter for providing power required for operating the driving circuit.

9. A driving circuit of an LED (light emitting diode) display capable of reducing power consumption comprising:
an LED for providing a light source;
a current source having a first end coupled to a first end of the LED for providing forward-biased current required for operating the LED;
a comparator having a first input end coupled to a reference voltage and a second input end coupled to the first end of the current source for generating a control voltage based on voltage levels of the first end of the current source and the reference voltage; and
a voltage converter having an input end coupled to an input voltage, a control end coupled to the output end of the comparator, and an output end coupled to a second end of the LED for providing the LED with an adaptive regulated voltage based on control voltages sent from the output end of the comparator.

10. The driving circuit of claim 9 wherein the voltage converter includes a boost converter.

11. The driving circuit of claim 9 wherein the voltage converter includes a buck converter.

12. The driving circuit of claim 9 wherein the second end of the current source is coupled to ground.

13. The driving circuit of claim 9 wherein the voltage converter, the current source and the comparator are fabricated on a same chip.

14. The driving circuit of claim 9 further comprising an input power source coupled to the input end of the voltage converter for providing power required for operating the driving circuit.
